(19) United States
(12) Patent Application Publication
(10) Pub. No.: US 2007/0248314 A1
(43) Pub. Date: Oct. 25, 2007

(54) Method and apparatus for controlled viewing of recorded television programs

(75) Inventor: Jerry Iggulden, Los Angeles, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Televentions, LLC

(21) Appl. No.: 11/408,292

(22) Filed: Apr. 20, 2006

(51) Int. Cl. H04N 5/91

(52) U.S. Cl. 386/68

(57) ABSTRACT

Segments of a recorded video program that are classified to be skipped during replay are scanned through at a predetermined rate, which is independent of viewer control. While faster than the normal play mode, the rate of forward scan is such that the content of the video segments being skipped can still be readily perceived. While in this controlled forward scan mode, viewer control of the scanning rate may be disabled. A viewer-controlled input may be provided so that a portion of a video segment being skipped can be viewed at a normal rate of play starting at the beginning of the portion that the viewer wishes to see. Once that portion of the video segment has been played at normal speed, the video playback device automatically switches to a predetermined mode of operation. Segments of a recorded video signal may be automatically rearranged for playback, allowing for all segments of one type to be played back contiguously, followed by playback of all segments of a second type.

### CROSS-REFERENCE TO RELATED APPLICATIONS AND PATENTS

The subject matter of this application is related to that of co-pending application Ser. No. 09/384,468, filed Aug. 27, 1999. The subject matter of this application is also related to that of issued U.S. Pat. Nos. 5,333,091; 5,692,093; 5,696,866; 5,987,210 and 5,999,688. The disclosures of the aforementioned patent application and issued patents are incorporated herein by reference.

### FIELD OF THE INVENTION

This invention relates to the field of video recording and playback systems and, more particularly, to a method and apparatus for controlling the playback of certain segments of a recorded video signal.

### BACKGROUND

The above-mentioned patent application and issued patents relate to various aspects of a system for bypassing commercial messages in a recorded television program. This system has been widely available in both video cassette recorders (VCRs) and digital video recorders (DVRs) under the trademark Commercial Advance®. As a television program is recorded or subsequent thereto, events within the video signal are detected and analyzed. Such events, typically “black frames”, are found within commercial television broadcast signals at the beginning and end of nearly every commercial message. By analyzing the timing of such events, the commercial messages within the broadcast signal may be identified with a high degree of accuracy. When the recorded broadcast signal is played back, the commercial messages may be automatically scanned through at a high rate of speed or, in the case of DVR recordings, may be skipped entirely.

The advent of DVRs, even without the Commercial Advance® system, has radically changed television viewing habits. Time-shifted viewing of television broadcasts, which was difficult for many viewers to properly program with VCRs, is easily accomplished with a DVR. Furthermore, DVRs permit time-shifted viewing of a television broadcast even as the broadcast is still in progress. Surveys have shown that one of the features most valued by DVR owners is the ability to rapidly scan through commercial messages. As indicated above, this can be accomplished automatically in DVRs equipped with the Commercial Advance® system. Without the Commercial Advance® system, the viewer can use a remote control to enter a fast-forward mode when the beginning of a commercial message is observed. The viewer then watches for the resumption of the program and uses the remote control to return to the play mode. Often, it will be necessary to scan through a portion of a video in reverse in order to find the beginning of the program segment. Thus, the viewer may need to engage in a “toggle drill” with the remote control to skip through commercial messages without missing portions of the program. Such a toggle drill can be annoying and frustrating for the viewer.

Typically, viewers are able to select the speed at which they manually scan through commercials using their remote controls. Most often, viewers will use the highest available scanning speed, which may be 32 times the normal play speed or even greater. At these speeds, viewers are cognizant that commercials are being played, but the content of the commercials is unlikely to register with the viewers, particularly since there is no audio while scanning. Consequently, the cost of producing and airing commercials is largely wasted on such viewers. If the scanning speed is limited to about 10 times the normal play speed or so, commercials can still make a mental impression with viewers even though he viewer is relieved of having to watch the commercials in real time.

The Commercial Advance® system is relatively easy to implement in digital video recording devices, including both DVRs and DVD recorders. Because of the digital processing capabilities inherent in such devices, it is also relatively easy to implement more advanced features and functions.

### SUMMARY OF THE INVENTION

The present invention provides improved methods for processing a video signal, particularly a signal comprising program segments interspersed with commercial messages. The improved methods utilize as a foundation the Commercial Advance® system disclosed in the above-cited patent application and issued U.S. patents. This system controls the operation of a video playback device while playing back a video signal containing a plurality of video segments bounded by events. When playback reaches an event at the beginning of a video segment to be skipped, such as the beginning of a cluster of commercials, the video playback device automatically switches from the play mode to a forward scanning mode. The video playback device then automatically switches back to the play mode at the end of the video segment to be skipped, e.g., at the resumption of the program.

In one aspect of the present invention, the video segment to be skipped is scanned through at a predetermined rate, which is independent of viewer control. While faster than the normal play mode, the rate of forward scan is such that the content of the video segment being skipped can still be readily perceived. While in this controlled forward scan mode, viewer control of the scanning rate is disabled.

In another aspect of the present invention, a viewer-controlled input is provided so that a portion of a video segment being skipped can be viewed at a normal rate of play starting at the beginning of the portion that the viewer wishes to see. Once that portion of the video segment has been played at normal speed, the video playback device automatically switches to a predetermined mode of operation.

In yet another aspect of the present invention, segments of a recorded video signal are automatically rearranged for playback, allowing for all program segments of a recorded video signal to be played back contiguously, followed by playback of all of the commercial segments.

### BRIEF DESCRIPTION OF THE DRAWINGS

FIG. 1 is a timing diagram of a portion of a video signal.

FIG. 2 diagrammatically illustrates operation of a video playback device in accordance with an embodiment of the present invention.

FIG. 3 diagrammatically illustrates operation of a video playback device in response to a viewer-controlled REVIEW command.

FIG. 4 is another timing diagram of a portion of a video signal.

FIG. 5 is a timing diagram illustrating the playback of the video signal shown in FIG. 4 in accordance with an embodiment of the present invention.

### DETAILED DESCRIPTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

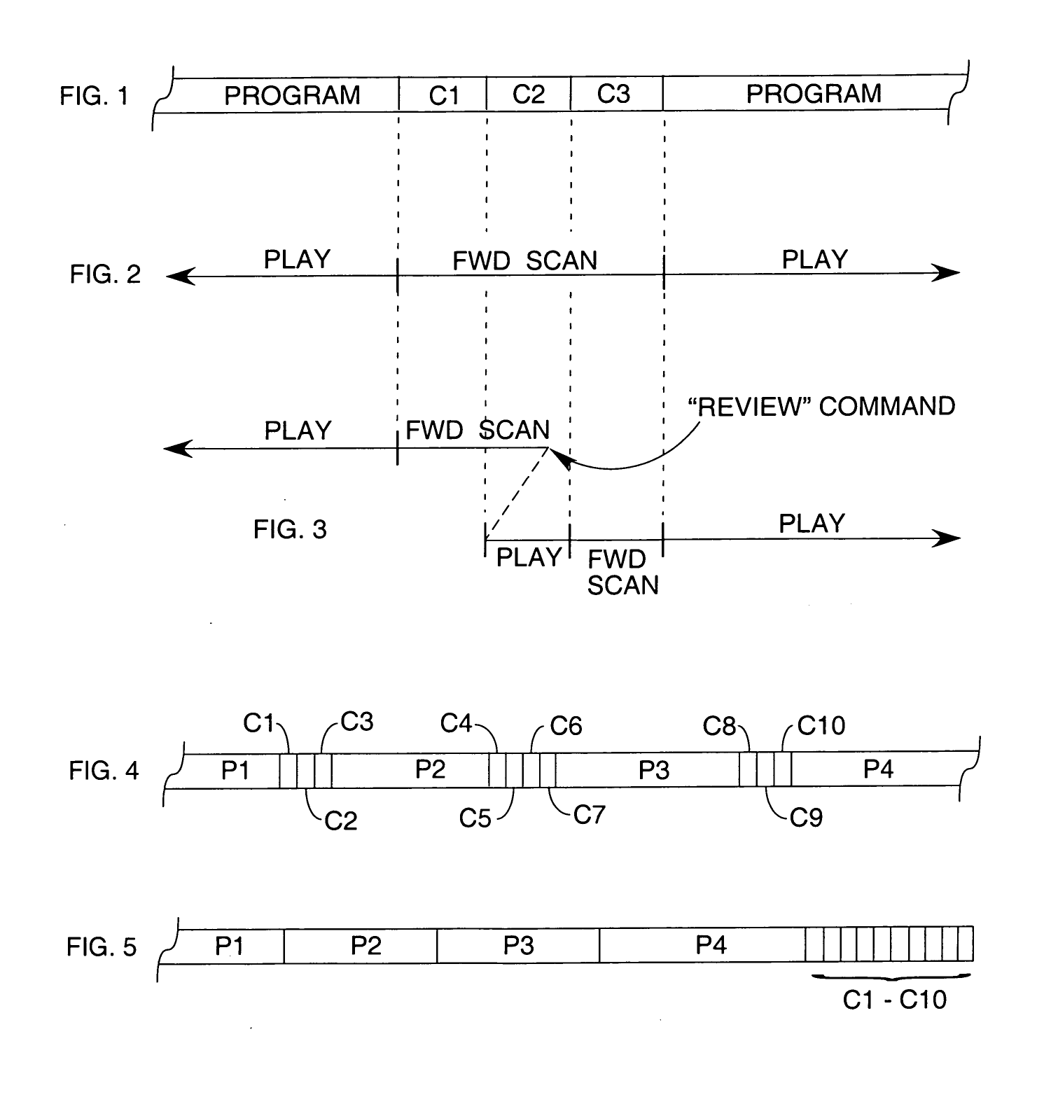

FIG. 1 illustrates a portion of a typical television broadcast. The program material is interrupted by groups or clusters of commercials. Here, a single commercial cluster comprising commercials C1, C2 and C3 is shown. “Commercials” include paid advertising, public service announcements, promotional spots or “teasers”, and other non-program material. A typical one-hour program on broadcast television may be interrupted by four or five commercial clusters aggregating nearly twenty minutes in length.

FIG. 2 illustrates operation of a video playback device in accordance with an embodiment of the present invention. “Video playback devices” include DVRs (both stand-alone and combined with broadcast receiver/tuners), DVD recorders, personal computers with video recording and playback capabilities, remote video storage services (both cable and Internet based) and other means for delivering previously recorded video programming. During the first program segment P1, the device operates in the normal play mode. When a video event corresponding to the beginning of commercial C1 is detected, the device automatically enters a forward scanning mode. The device remains in the forward scanning mode until a video event corresponding to the end of commercial C3 and the beginning of program segment P2 is detected. The device then returns to the normal play mode.

It will be appreciated that forward scanning of commercials C1, C2 and C3 can be accomplished at virtually any speed. Indeed, the video output of the device can skip virtually instantaneously from the beginning of commercial C1 to the end of commercial C3, subject only to the mechanical limitations of the recording medium. It may be desirable, however, to control the speed of forward scanning so that the content of the commercials remains perceptible to the viewer. At a scan speed of ten times normal play, for example, a typical thirty second commercial is compressed to three seconds. For most viewers, this is long enough to readily perceive the content of the commercial.

At 10× normal play, the forward scanning mode may simply display every tenth frame of the recorded video signal. Alternatively, a number of contiguous frames may be displayed at the normal frame rate before advancing to a subsequent group of frames. For example, at a 10× forward scanning rate, six contiguous frames out of sixty could be displayed. For a typical thirty second commercial, this would provide the viewer with fifteen “snapshots” of the commercial.

Normally, there is no audio in a forward scanning mode. However, an audio signal may be sampled from the scanned segment and presented to the viewer if desired. At a 10× scan rate, a typical thirty second commercial is scanned past in three seconds. During this time, a three second sample of the commercial's audio signal may be presented. This could be the first or last three seconds of audio or could be a sample centered about the highest audio amplitude. More sophisticated sampling criteria may be employed to select an audio sample most likely to convey meaningful information. The audio sample may cover a longer period of time than the scan time of the commercial and be correspondingly compressed. For example, a four and a half or six second sample could be used and played back at one and a half or two times normal speed, respectively. Pitch correction may be employed to improve comprehension of the time-compressed audio.

Remote controls for DVRs and similar devices include “fast forward” buttons as is well known. These permit the viewer to manually skip through portions of the recorded program by playing them at a higher than normal speed. In many implementations, repeated pushing of the fast forward button increases the speed at which the program is played, in many cases as much as 32 times the speed of normal play or greater. With the controlled forward scanning of the present invention, it is desirable to disable viewer control of the fast forward function so that the preset speed at which commercials are played cannot be exceeded.

FIG. 3 illustrates operation of a video playback device in accordance with an embodiment of the present invention wherein the viewer is afforded the opportunity to review a commercial that has been seen in the forward scanning mode. The viewer is provided with a “REVIEW” button on the remote control for the device, which may be a dedicated button or may be a button whose functionality is shared among different modes of operation. As commercials are played in the forward scanning mode, the viewer, upon seeing a commercial of interest, may press the REVIEW button on the remote control. Upon receiving the command, the playback device searches for the video event corresponding to the commercial playing at the time the command was received and begins normal play at the beginning of the commercial, in this case C2. At the end of commercial C2, the device returns to the forward scanning mode for presentation of commercial C3. If the commercial to be viewed is the last in a cluster, the device would remain in the normal play mode for continuation of the program. If a viewer presses the REVIEW button after the commercial of interest, e.g., if the button is pressed during commercial C3 but the viewer wanted to review commercial C2, the viewer can simply press the REVIEW button again when commercial C3 begins playing to go back to the beginning of commercial C2.

FIG. 4 is a timing diagram of a typical broadcast television signal similar to FIG. 1, but showing an entire program. In this example, the program comprises segments P1-P4. The program segments are interspersed with commercials C1-C10 in three separate clusters.

FIG. 5 is a timing diagram illustrating playback of the signal of FIG. 4 when the segments have been rearranged for non-linear viewing. Program segments P1-P4 are first presented contiguously, followed by commercials C1-C10. The viewer is thus able to view the program without interruption, but is still able to view all of the commercials. The commercials may be presented either in the normal play mode or in the forward scanning mode. In the latter case, the viewer may still select a commercial for review in the manner described above.

After viewing a recorded program, the viewer may choose to delete the program from the recording medium. Since the Commercial Advance® system automatically “indexes” the program by virtue of detecting video events and classifying the video segments between events as “program” or “commercial”, the viewer may elect to selectively delete certain segments form the recording medium while retaining others. For example, the viewer may elect to retain all program segments and delete all commercial segments or vice versa. Furthermore, the viewer can elect to retain only certain commercial segments that the viewer has identified as being of interest, such as by reviewing such segments in the manner described above.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

1. In a video playback device having a play mode, a forward scanning mode and a set of viewer-controlled commands, a method of controlling operation of the video playback device while playing back a video signal containing a plurality of video segments bounded by events, the method comprising:
automatically switching from the play mode to the forward scanning mode at a predetermined scan rate upon detection of an event in the video signal;
disabling a subset of the viewer-controlled commands for the duration of a video segment following the detected event; and
automatically switching to the play mode at the end of the video segment following the detected event.

2. The method of claim 1 wherein the video segment following the detected event comprises at least one commercial message.

3. The method of claim 1 wherein the subset of viewer-controlled commands comprises a fast forward command.

4. The method of claim 1 wherein the predetermined scan rate is less than 32 times the play mode rate.

5. The method of claim 1 wherein the forward scanning is accompanied by an audio output.

6. The method of claim 5 wherein the audio output is sampled from an audio signal associated with the video segment following the detected event.

7. The method of claim 1 further comprising deleting video segments of a first type from a storage medium without deleting video segments of a second type.

8. The method of claim 1 further comprising selectively saving at least one of the plurality of video segments on a storage medium.

9. In a video playback device having a play mode and a forward scanning mode, a method of controlling operation of the video playback device while playing back a video signal containing a plurality of video segments bounded by events, the method comprising:
automatically switching from the play mode to the forward scanning mode at a predetermined scan rate upon detection of an event in the video signal;
automatically returning to a beginning of a video segment to be reviewed upon receipt of a viewer-controlled command to review a video segment seen in the forward scanning mode;
automatically switching to the play mode at the beginning of said video segment to be reviewed; and
automatically entering a predetermined mode of operation at an end of said video segment to be reviewed.

10. The method of claim 9 wherein the video segment to be reviewed comprises a commercial message.

11. The method of claim 9 wherein the predetermined mode of operation is a resumption of the forward scanning mode.

12. The method of claim 9 wherein the predetermined mode of operation is a continuation of the play mode.

13. The method of claim 9 wherein the predetermined scan rate is less than 32 times the play mode rate.

14. The method of claim 9 wherein the forward scanning is accompanied by an audio output.

15. The method of claim 14 wherein the audio output is sampled from an audio signal associated with a video segment following the detected event.

16. The method of claim 9 further comprising selectively saving the video segment to be reviewed on a storage medium.

17. The method of claim 9 further comprising deleting video segments of a first type from a storage medium without deleting video segments of a second type.

18. A method of controlling operation of a video playback device while playing back a video signal containing a plurality of video segments of a first type interspersed with a plurality of video segments of a second type comprising first automatically playing back all of the video segments of the first type and then automatically playing back all of the video segments of the second type.

19. The method of claim 18 wherein the video segments of the second type are played back at a higher playback speed than the video segments of the first type.

20. The method of claim 19 wherein the video segments of the second type are accompanied by an audio output.

21. The method of claim 20 wherein the audio output is sampled from an audio signal associated with the video segments of the second type.

22. The method of claim 18 wherein the video segments of the first type comprise program segments and the video segments of the second type comprise commercial messages.

23. The method of claim 18 further comprising deleting the video segments of the first type from a storage medium without deleting the video segments of the second type.

24. The method of claim 18 further comprising deleting the video segments of the second type from a storage medium without deleting the video segments of the first type.

25. The method of claim 18 further comprising selectively saving at least one of the plurality of video segments of the second type on a storage medium.

26. In a video playback device having a play mode, a forward scanning mode and a set of viewer-controlled commands, a method of controlling operation of the video playback device while playing back a video signal containing a plurality of video segments bounded by events, the method comprising:
automatically switching from the play mode to the forward scanning mode at a predetermined scan rate upon detection of an event in the video signal;
accompanying the forward scanning with an audio output sampled from an audio signal associated with a video segment following the detected event; and
automatically switching to the play mode at the end of the video segment following the detected event.

27. The method of claim 26 wherein the audio output is sampled from a last portion of the audio signal.

28. The method of claim 26 wherein the audio output is a compressed sample of the audio signal.

29. The method of claim 28 further comprising applying pitch correction to the audio output.
